(19) United States
(12) Patent Application Publication
(10) Pub. No.: US 2009/0124360 A1
(43) Pub. Date: May 14, 2009

(54) THEME BASED PROMOTION CASH OUT TICKET FOR A GAMING MACHINE

(75) Inventors: Michel Vienneau, Dieppe (CA); Sylvio LeBlanc, Dieppe (CA); Jean-Louis Drapeau, Dieppe (CA); Scott Stewart, Las Vegas, NV (US)

Correspondence Address: SEAN LIAM KELLEHER;Kelleher IP PLLC, 16 PECKSLIP RD, CARMEL, NY, 10512, US

(73) Assignee: NANOPTIX, INC., Dieppe, NB (CA)

(21) Appl. No.: 12/258,420

(22) Filed: Jan. 21, 2009

Related U.S. Application Data
(60) Provisional application No. 60/983,138, filed on Oct. 26, 2007.

(51) Int. Cl. A63F 9/24; G06F 19/00

(52) U.S. Cl. 463/25; 463/47

(57) ABSTRACT

The present invention provides a method that enables the possibility of adding promotions or themes to a printed cashout ticket without a need to modify the central system controller or modifying the host gaming machine. The present invention also provides a printer with selector means and a memory data bank which allows for the possibility of adding promotions or themes to a printed cashout ticket without a need to modify the central system controller or modifying the host gaming machine

### BACKGROUND OF THE INVENTION

1. Field of the Invention

The present invention relates generally to printers and more specifically to gaming machine printers that can provide promotions or theme based cashout tickets.

2. Summary of the Art

In recent years, slot machines, lottery terminals and other type of wagering or transactions started using printed ticket coupons instead of issuing cash, tokens or credits. These printed tickets usually comprise of a bar coded validation number that can be validated by all sorts of reading devices encompassed in the type of apparatus as described above. These highly secured systems are closely monitored and controlled by Central System Controllers which makes adding any features on the tickets very difficult.

Others have suggested different method of issuing vouchers and coupon. One method comprises of using a special interface to accept printing instructions from one port for cashout tickets and accepting printing instructions from another port to print out vouchers or coupons as described, for example, under U.S. Pat. No. 6,924,903.

The prior art has not addressed a manner of printing them information directly on a cashout ticket, without affecting the security features incorporated into the cashout ticket process, including cyclical redundancy checks (CRCs) of the data sent to produce the cashout ticket. Accordingly, there is a need for such themes and promotional material on the cashout ticket, for example to advise players as to entertainment and food options at the casino.

### SUMMARY OF THE INVENTION

It is an object of the present invention to provide an improvement to the printing of cashout tickets as utilized in gaming machines. Specifically, it is an object of the present invention to provide the possibility of adding promotions or themes to a printed cashout ticket from a gaming machine without modifying the Central System Controller or modifying the Host Machine.

### BRIEF DESCRIPTION OF THE DRAWINGS

It will now be convenient to describe the invention with particular reference to one embodiment of the present invention. It will be appreciated that the figures relate to one embodiment of the present invention and are not to be taken as limiting the invention.

FIG. 1 is an example of a cashout ticket according to one embodiment of the present invention;

FIG. 2 is a block diagram according to one embodiment of the present invention;

FIG. 3 is a flowchart of the specific method utilized according to one embodiment of the present invention;

FIG. 4 is an example of a dual in-line package (DIP) switch and its settings as would be found in a printer for a gaming machine according to one embodiment of the present invention; and

FIG. 5 is a configuration table for DIP switches according to one embodiment of the present invention.

### DETAILED DESCRIPTION OF THE INVENTION

The present invention relates to a method of issuing a printed cashout ticket in gaming machines with an add-on image on the cashout ticket for promotions or marketing without affecting the security of the Central System Controller by avoiding change in the cycle redundancy check (CRC) of the printer each time a theme is changed for promotion purposes.

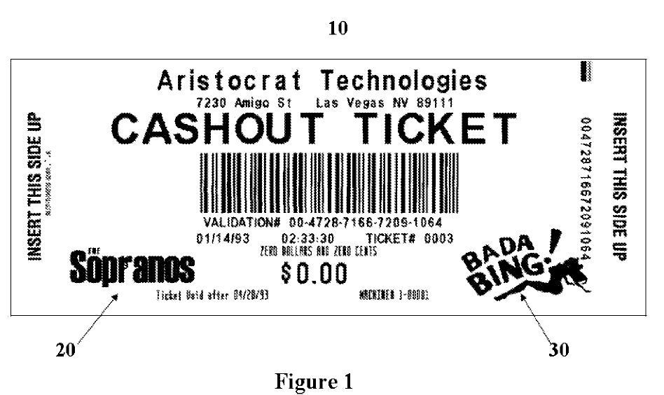

With reference to FIG. 1, a cashout ticket 10 according to one embodiment of the present invention is shown. The theme or promotion is presented as a first drawing 20 and a second drawing 30. The first and second drawing 20 and 30 can be printed in reserved areas of the ticket 10 not presently used for existing critical and mandatory field of ticket 10 for security reasons. In one embodiment of the present invention, the drawings 20 and 30 are stored in a series of graphics or combinations of graphics and text in the form of bitmap in the printer memory data bank allowing for the printer to independently print to the existing field of printing instructions from the stored series of graphics, or a combination of graphics and text. The theme may involve blank graphics and text; in effect, no theme is also an option for the choice of a theme. While the preferred embodiment employs a thermal printer, a person skilled in the art would appreciate that other types of printers could be employed and still achieve the desired results.

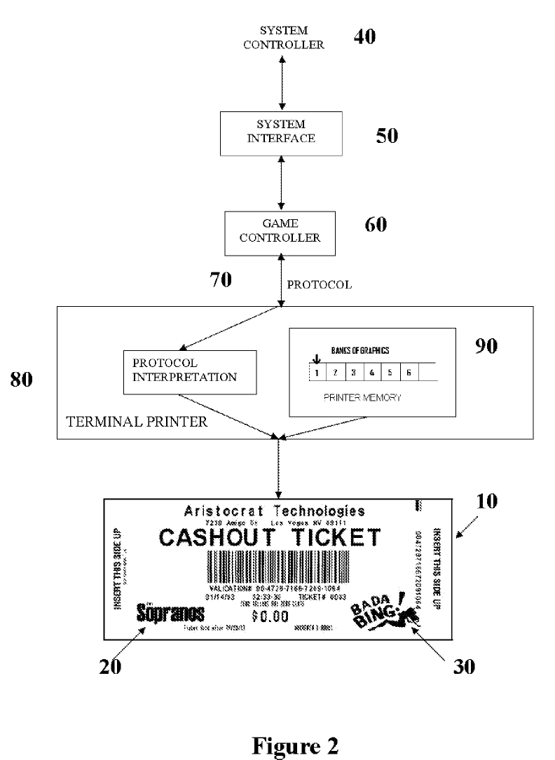

With reference to FIG. 2 and according to one embodiment of the present invention, a system controller 40 interacts with a system interface 50. Through system interface 50, a game controller 60 as would be found in a gaming machine, interacts with the system interface. A worker skilled in the relevant art would be familiar with the need of a system controller 40 to assure security of all gaming information with a series of gaming machines. Through the interaction of the game controller and the system interface, upon a request to print a cashout ticket, the system controller 40 provides authorization to the game controller 60 through interaction with the system interface 50 prompting the game controller to provide a specific protocol 70 to the terminal printer 80. Once the protocol 70 is received, the terminal printer 80 deciphers the protocol in order to issue or print a secure and valid cashout ticket for the patron. Upon activation, the terminal printer 80 will read a selector means, which in this preferred embodiment comprises one or more dual in-line package (DIP) switches, and will reproduce any theme based on the settings of the DIP switches, which are associated with a data bank for computer graphics implemented in the printer memory. A person skilled in the art would appreciate that the selector means may be implemented in several ways, including selection by software or hardware means. A more detailed description of the theme to be reproduced on the cashout ticket is found below. With further reference to FIG. 2, the cashout ticket 10 has a first drawing 20 and a second drawing 30 represented on it. These specific drawings 20 and 30 are only reproduced based on the specific settings of the DIP switches in the terminal printer.

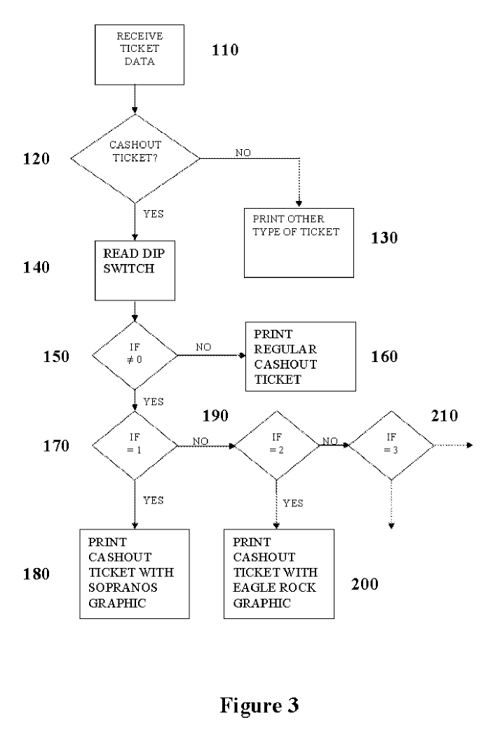

With reference to FIG. 3 and according to one embodiment of the present invention, once the ticket data 110 is received, the terminal printer of a gaming machine (not shown) considers if the ticket data 110 has any request for a cashout at step 120. If the ticket data 110 has no information requesting a cashout ticket at step 120, the terminal printer will simply print the requested ticket based on the information provide within the ticket data at step 130. If, however, there is a cashout request in the ticket data 110 at step 120, the terminal printer will read the DIP switches associated with the printer at step 140. Specifically and according to one embodiment of the present invention, the DIP switches will identify to the terminal printer from which, if any, data banks the terminal printer needs to retrieve the specific graphic to be reproduced on the cashout ticket. If no DIP switches are present within the printer at step 150, the terminal printer will simply issue a cashout ticket at step 160.

With further reference to FIG. 3, if DIP switches are present within the terminal printer at step 150, the printer will review at step 170 the specific settings of DIP switch 1. For example, if DIP switch 1 is equal to 1 then the printer will retrieve a theme based on the Sopranos television from the data bank and reproduce it at step 180 on the cashout ticket. In the alternative, if DIP switch 1 is not equal to 1, the printer will proceed to read DIP switch 2 at step 190. If DIP switch 2 is equal to 2 at step 190, then the printer will retrieve an Eagles rock band graphic from a different spot in the data bank from that associated with DIP switch 1, and reproduce it on the cashout ticket at step 200. In the alternative, if DIP switch 2 at step 190 is not equal to 2, the printer will proceed to read DIP switch 3 at step 210 and conduct a similar loop as described for DIP switch 1 and 2, resulting in yet another different graphic for the ticket. A worker skilled in the relevant art would be familiar with this type of application has being able of having N possibilities based on the number of DIP switches on the printer circuit board.

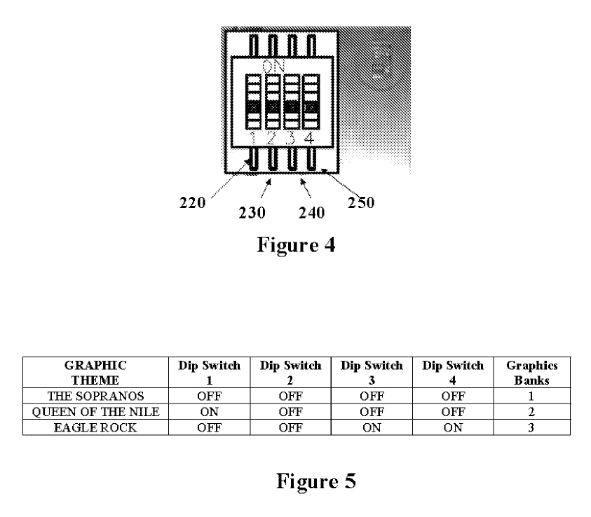

With reference to FIG. 4 and according to one embodiment of the present invention, an example of DIP switch settings is shown. Under this embodiment, a series of four DIP switches 220, 230, 240 and 250 are presented wherein all DIP switches are off which is represented by the symbol X above each of the respective DIP switches. This specific setting could represent, for example, that no voucher or drawing be associated with the cashout ticket.

With reference to FIG. 5, a table representing examples of DIP switch settings as represented under FIG. 4 is shown. For example, in the case of a series of four DIP switches, all of which are defined as “OFF”, a certain theme will be represented on the cashout ticket, in the form of graphics and text, taken from data bank 1. In this case data bank 1 is identified by the combination of the settings of the DIP switches. In this example, each data bank of graphics can have up to 25 different graphics which can be retrieved in sequence or at random within the data bank. The number of data banks and the contents of each data bank will be limited by the memory allocation on the printer memory card.

With further reference to FIG. 5, the terminal printer may have several series of four DIP switches and upon having reproduced all graphics within data bank 1, it may then commence reproducing the graphics in data bank 2 until all of these have been reproduced on cashout tickets, after which it draws graphics from data bank 3.

With further reference to FIG. 5, the DIP switch setting for data bank 2 is defined by DIP switch 1 being equal to 1 (ON) and all other three DIP switches are equal to 0 (OFF). A further example of DIP switch setting is wherein DIP switch 3 and 4 are on and DIP switch 1 and 2 are off, and together represent graphics associated with data bank 3. A worker skilled in the relevant art would understand that a setting of off in a DIP switch is represented by a 0 and a setting of on is represented by a 1 as DIP switch settings are basic binary numbers.

A worker skilled in the relevant art would also be familiar with the fact that this invention makes it possible to offer a multiple set of graphic themes by simply switching the bank of bitmaps as found on the terminal printer memory, and selecting between them by means of a selector means. This can be achieved without affecting the cycle redundancy check (CRC) of the printer which is a key aspect in order to enable this type of promotion in this much secured environment. Such examples include but are not limited to:

1. By changing a set of DIP switch on the printer, or anywhere else in the gaming machine.

2. By changing the BIX files from an outside controller, for example, a computer or handheld device.

3. By switching external memory cards, for example, SD Cards or Memory Cards on the printer, or anywhere else in the gaming machine.

4. Any other type of device or system that enables changing the data bank of bitmap graphics without affecting the CRC of the printer.

A worker skilled in the relevant art would also be familiar with the types of graphics that can be associated with this application. Examples of these graphics could include but are not limited to:

1. A series of graphics promoting a specific game theme on a slot machine (or other type of machines as described above).

2. A series of graphics promoting a specific manufacturer of slot machine (or other type of machines as described above).

3. A series of graphics promoting a special event from the casino or from the manufacturer of the machine.

4. A series of graphics promoting a sweepstake by text messaging to a number or referring to a web site.

A worker skilled in the relevant art would also be familiar that the reading of any DIP switches can be activated upon any communication to the terminal printer or any other communication to the gaming machine.

A worker skilled in the relevant art would be familiar with the fact that a DIP switch is an electric switch that is packaged in a group in a standard dual in-line package and that the whole package may also be referred to as a DIP switch in the singular. A worker skilled in the relevant art would also be familiar with the fact that DIP switch is designed to be used on a printed circuit board along with other electronic components and is commonly used to customized behavior of an electronic device for specific situations as defined above.

It is to be understood that the above description of one embodiment of the present invention is provided as an example only. Various details of the application may be modified without departing from the scope of the invention.

1. A method of printing a theme based cashout ticket for a gaming machine comprising the steps of:
a) receiving ticket data on a printer for said gaming machine;
b) determining if said cashout ticket is being requested from said ticket data;
c) reading a selector means to determine said theme for said cashout ticket; and
d) printing said theme from a data bank on said cashout ticket wherein a ticket is printed if a cashout ticket is not requested by said ticket data.

2. The method of claim 1 wherein the selector means is a DIP switch.

3. The method of claim 1 wherein the selector means is a computer file.

4. The method of claim 1 wherein the selector means is a memory card.

5. The method of claim 1 wherein the data bank contains computer graphics.

6. The method of claim 1 wherein the databank contains a combination of text and graphics.

7. A printer for printing a cashout ticket for a gaming machine comprising:
a) a selector means for selecting a theme; and
b) a memory data bank
wherein said selected theme is printed on said cashout ticket by said printer.

8. The printer of claim 7 wherein the selector means is a DIP switch.

9. The printer of claim 7 wherein the selector means is a computer file.

10. The printer of claim 7 wherein the selector means is a memory card.

11 .The printer of claim 7 wherein the data bank contains computer graphics.

12. The printer of claim 7 wherein the databank contains a combination of text and graphics.
